(19) United States
(12) Patent Application Publication
(10) Pub. No.: US 2024/0007823 A1
(43) Pub. Date: Jan. 4, 2024

(54) ACELLFX PROXIMITY DETECTION SYSTEM

(71) Applicant: Donnell B Dillon, Indianapolis, IN (US)

(72) Inventor: Donnell B Dillon, Indianapolis, IN (US)

(21) Appl. No.: 16/946,921

(22) Filed: Jul. 10, 2020

(51) Int. Cl. H04W 4/029; H04W 4/021; H04W 4/14; G06F 3/16

(52) U.S. Cl. CPC H04W 4/029; H04W 4/021; H04W 4/14; G06F 3/167

(57) ABSTRACT

Monitoring Proximity Alert System that protect Homeowner's, Businesses, and School institutions. The APD System Integrates Criminal offenders tracking monitoring with home and business security systems. APDS was designed for offenders convicted of violent and sexual crimes released out on parole or probation. The secure wireless bracelet device would have capabilities designed to meet the requirement of conventional judicial monitoring programs already in use. In detail The Acellfx Bracelet transmits an identifying numeric signal that will be detected by the proximity sensors surrounding the property. When the bracelet triggers the system, the systems sets off an alert whenever the offender wearing the bracelet is within proximity of the protected property. The system then collects the data received from the proximity sensors that detected the transmitting device (Bracelet) then time stamps the information and then sends it via over the internet to the local law enforcement database and monitoring facilities.

### BACKGROUND OF INVENTION

The background of THE ACELLFX PROXIMITY DETECTION SYSTEM is in the home security system industry. It would meet the equipment authorization requirements for Part 15 of the FCC rules and regulations relating to electromagnetic devices classified as intentional radiators, as well as Part 68 of the FCC rules and regulations relating to telecommunications equipment. THE ACELLFX PROXIMITY DETECTION SYSTEM can be assembled using a combination of surface-mount technology (SMT) Ball Grid Array (BGA) or Fine Ball Grid Array (FBGA) components as well as precision component positioning equipment and soldering station equipment. Embedded component printed circuit board technologies may be considered for additional form factor reduction potential.

Ball Grid Array (BGA) Integrated circuit components differ from the earlier generation of dual in-line packaged (DIP) integrated circuit SMT components in that BGA components can have input/output interconnections to a circuit board across the entire underside surface of the BGA component. In contrast, dual in-line package SMT components only have input/output interconnections along their perimeter.

### BRIEF SUMMARY OF INVENTION

THE ACELLFX PROXIMITY DETECTION SYSTEM is a new added layer of security for homeowner's, businesses, schools, and numerous of institutions that protects their occupants from undesirable individuals such as
1. SEXUAL OFFENDERS
2. INDIVIDUALS ON RESTRAINING ORDERS
3. HABITUAL OFFENDERS OF VIOLENT CRIMES AND THEFT

### DRAWINGS

FIG. 1 illustrates the architecture of an exemplary electronic monitoring system in accordance with the principles of the present invention;

FIG. 2 illustrates details of the architecture of the exemplary electronic monitoring system shown in FIG. 1;

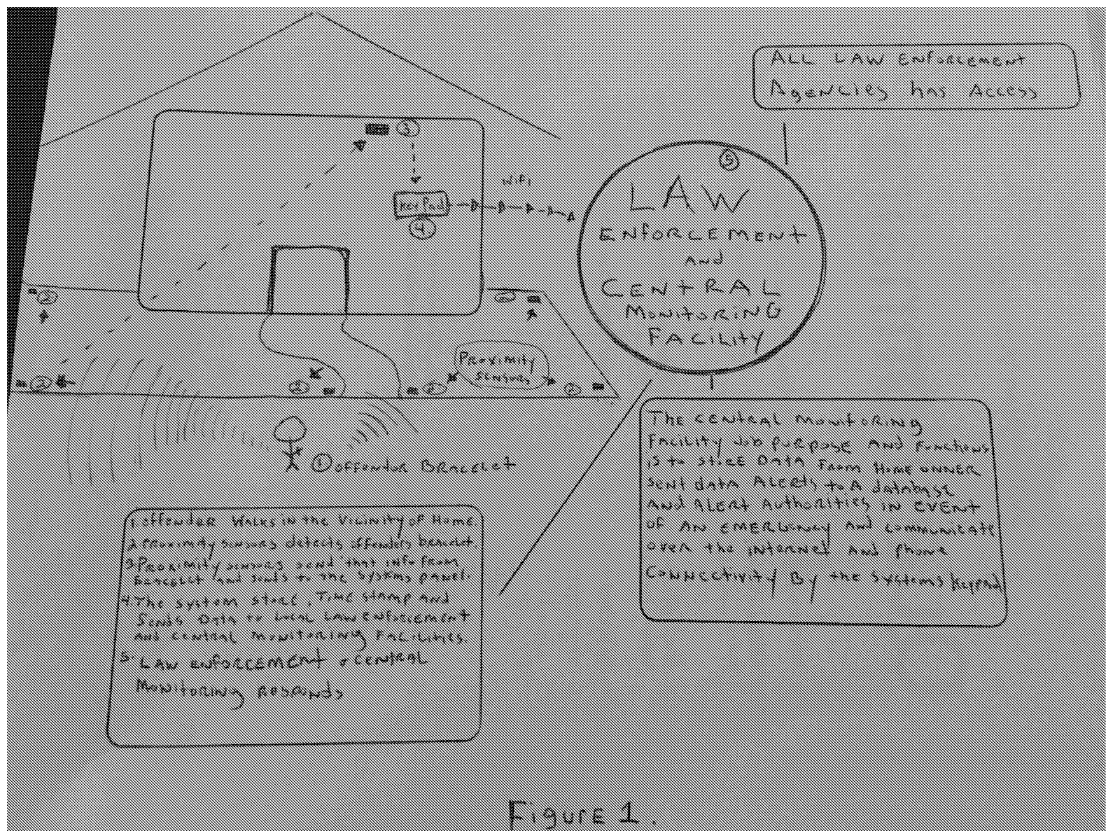

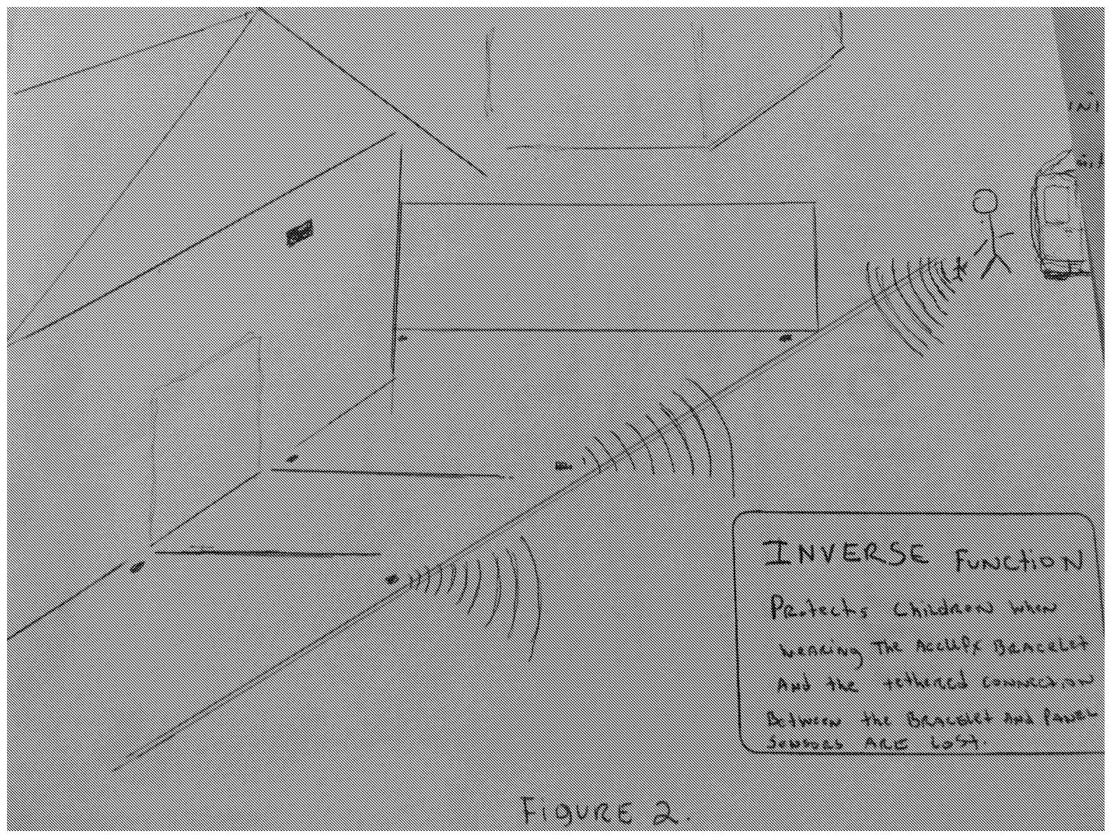

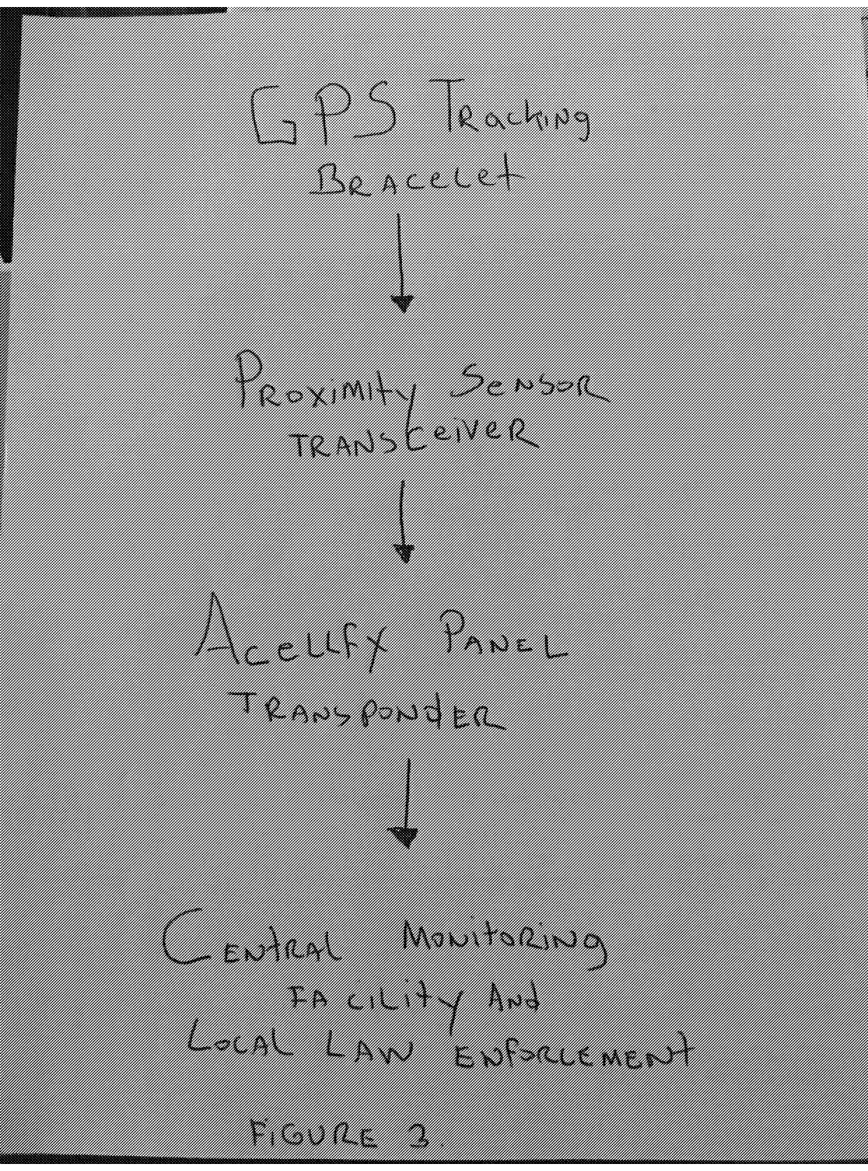

FIG. 1 illustrates details of an exemplary client tracking unit bracelet, Proximity sensors and monitoring unit panel employed in the system shown in FIGS. 1 and 2;

FIG. 1 illustrates details of an exemplary transmitter, or bracelet, employed in the system shown in FIGS. 1 and 2;

FIG. 1 illustrates basic communication between the monitoring device and the monitoring center of the exemplary electronic monitoring system shown in FIGS. 1;

FIG. 1 illustrate operations that are performed in sequence using the monitoring device;

FIG. 1 (1) illustrate when the offender walks in vicinity of the Proximity sensors monitoring device system;

FIG. 1 (2) illustrate when the proximity sensors detect the GPS, Bluetooth, or Cellular monitored bracelet using the monitoring device system;

FIG. 1 (3) illustrate when the proximity sensors sends the downloaded information collected from the Acellfx bracelet to the sensors then it is sent to the Acellfx Panel monitoring device system;

FIG. 1 (4) illustrate the Acellfx proximity detection system store and time stamp and sends the data to local law enforcement and central monitoring facilities;

FIG. 1 (5) illustrate how the Local law Enforcement and Central Monitoring Facilities respond;

FIG. 2 illustrate the inverse function of The Acellfx Proximity Detection System;

FIG. 3 illustrate the sequence of events The Acellfx Proximity Detection System Operates;

### DESCRIPTION OF INVENTION

The Product concept in full description and name was an idea that was invented by me Donnell Brian Dillon born Mar. 29, 1977. The ACELLFX PROXIMITY DETECTION SYSTEM was an idea I've been building on to for approximately about 11 years. An idea invention in which I now call “THE ACELLFX PROXIMITY DETECTION SYSTEM” . . . The Acellfx PDS is an additional layer and blanket of security for home owners, businesses, schools and numerous of institutions to protect their occupants from criminally prosecuted individual such as persons on sexual offender's statuses, person having protection from abuse or restraining orders and habitual offenders. This proposed additional layer of security would relate to a new type of judicial monitoring program where offender under probation would be required to wear a secure wireless bracelet device. The bracelet device would have cellular and GPS tracking and Bluetooth capabilities with ranges up to a few hundred to several hundred feet. “The Acellfx Proximity Detection Systems bracelet” functions as a wireless identity signal that would transmit the wearer's identification and location data repeatedly to the system as the offender on probation moves about and around the premises.

The primary function of “THE ACELLFX PROXIMITY DETECTION SYSTEM” would relate to the use of companion wireless identity receivers that would be incorporated into the security system of residence, businesses, schools and other institutions. These wireless identity receivers could be used individually or combined in a larger network to provide the level of coverage needed to protect a given premises location When a premises location identity receiver detect “THE ACELLFX PROXIMITY DETECTION SYSTEM” beacon signal from an offender's bracelet. The system then alerts the premises occupants and/or the premises security staff as to the nearby presence and threat of a known offender.

Another feature that could add and added protection is the use of a mobile App. Whereby premises occupants and security staff could be alerted that there is a nearby presence of a known offender on their mobile devices via mobile App. The mobile app would allow the user to quickly determine the identity of the nearby offender his/her approximate location and pertinent information about the offender that would help the premises occupants to maintain their relatively level of personal safety. At the same time the secure wireless bracelet of “THE ACELLFX PROXIMITY DETECTION SYSTEM” would also be operating in its judicial monitoring mode to provide local law enforcement with near-real time information as to the location of the offenders on parole.

Also “THE ACELLFX PROXIMITY DETECTION SYSTEM” with upgraded capabilities with the original functions or stand alone can operate inversely with wireless devices intended to allow parents and guardians to electronically monitor the nearby whereabouts of children and other individuals. How it works is that when the wireless tether is broken, the child or other individuals is out of range and needs to be immediately located, a short range audible alert permits the parents or guardian to find the wandering child by following the sound of the alarm tone on the wireless device worn by the child with the additional GPS tracking of the app from a phone in possession of the parent or guardian to help locate the child or individuals wearing the bracelet. The inverse technology can also apply to pet owners and farmers who own livestock.

Recap A description of what my idea does: My invention is an additional blanket of security for Homeowners, businesses and school institutions. How it works is that the system detects a bracelet in which I call the Acellfx PDS bracelet required to be worn on persons of violent and habitual offenders, rapist and sexual predators.

How is my invention used? Once the offenders are within distance of said property the solar, cellular or Bluetooth sensors located on the premises detects the transmitting beacon Acellfx PDS bracelet signal and sends the signal to the receiving “ACELLFX PROXIMITY DETECTION SYSTEM”. The system stores the signal information and sends it to the homeowner's phone app and the local monitoring law enforcement facility data base in real-time. “THE ACELLFX PROXIMITY DETECTION SYSTEM” allows real-time communication between the System and the monitoring law enforcement facility.

Features I believe my idea is unique and appealing is that the system uses Bluetooth communication sensors that communicate with “ACELLFX PROXIMITY DETECTION SYSTEM”. The system can be integrated with a phone app and the system is an easy and simple install. Other variations that could be considered to make the product fully function able is that the Proximity sensors could use other methods of communicating with the system by either hard wire by cats data cable, radio transmitting frequencies and WIFI IP connections.

My idea was inspired in simply wanting to put in place a system that protects children and their families. Acellfx Proximity Detection System fulfills the need to prevent violent habitual offenders, sexual predators and child molesters who are on and off probation and parole and is purpose is to prevent and deter any offender from further committing any further crimes.

1-20. (canceled)

21. Acellfx Proximity Detection System is an integration between Home Security Systems, GPS Tracking Technology and Proximity Sensors. When the system is tripped or triggered the system sends detailed alarm notifications to the system's keypad, monitoring services and local law enforcement agencies and alert all occupants of the secured protected property of the potential threat in the vicinity in a timely manner.

22. Proximity Sensors detect transmitting devices (2) Alarm panel receives detailed information from the proximity sensors that receives data from the transmitting devices (3) Alarm Panel communicates detailed information to the monitoring facility (4) Monitoring Services facility communicates that information to the customer and local law enforcement agencies (5) End results is the local Law enforcement agencies are dispatched to neutralize any potential threat.

23. In detail habitual offenders of violent crimes required by law to wear monitoring bracelets walks in the proximity of a protected home/business/school/institutions will be recognized by the Acellfx Proximity Detection System. The Acellfx Proximity detection system proximity sensors detect the (Beacon, Bluetooth, RF, and Cellular) signals from the monitoring bracelet and sends the monitoring ID bracelet information to the panel's keypad when the signal is received. The Panel then sends the signals to the keypad, then the keypad alerts all occupants of potential threats in proximity of the protected home. The keypad beeps in the response of range of transmitting signals. The tones and length of the beeps increases, or patterns of beeps change the closer the (Beacon, Bluetooth, RF and Cellular) are close to the proximity sensors. The Monitoring bracelet would have the capabilities to communicate what level of possible threat and dictate path of command to communicate to send to the proximity sensors in detail data such as low-level threat or severe threat and the identification of the offender in number sequence. The Acellfx Proximity Detection System receives this information and transmit this data by Ethernet, Phone line or Cellular Communicator to a monitoring facility and local law enforcement.
